(19) United States
(12) Patent Application Publication
(10) Pub. No.: US 2015/0062921 A1
(43) Pub. Date: Mar. 5, 2015

(54) LIGHT SOURCE DEVICE

(71) Applicant: HON HAI PRECISION INDUSTRY CO., LTD., New Taipei (TW)

(72) Inventors: LI-YING WANG HE, Tu-Cheng (TW); YI HUNG, Tu-Cheng (TW)

(73) Assignee: HON HAI PRECISION INDUSTRY CO., LTD., New Taipei (TW)

(21) Appl. No.: 14/054,843

(22) Filed: Oct. 16, 2013

(30) Foreign Application Priority Data
Aug. 27, 2013 (TW) 102130511

(51) Int. Cl. F21V 5/04; F21K 99/00

(52) U.S. Cl. CPC F21V 5/04; F21K 9/50; F21Y 2101/02
USPC 362/311.02; 362/311.01; 362/311.05

(57) ABSTRACT

The present disclose relates to light source device, which including a light source and a lens opposite to the light source. The lens includes a bottom surface, a light input surface, a top surface and a side surface. The light input surface depresses from the bottom surface towards a top surface of the lens. The light input surface is an aspheric surface. The top surface is opposite and parallel to the bottom surface. The side surface connects the bottom surface and the top surface. The side surface is a curved surface formed by rotating a curve line about the central axis of the lens. Light emitted from the light source enters the lens and is refracted by the side surface and the top surface of the lens to outside.

### BACKGROUND

1. Technical Field

The disclosure relates to light source devices, and particularly to a light source device with larger radiation angle.

2. Discussion of Related Art

Light emitting diodes' (LEDs) many advantages, such as high luminosity, low operational voltage, low power consumption, compatibility with integrated circuits, faster switching, long term reliability, and environmental friendliness have promoted their wide use as a lighting source.

However, the conventional LED cannot have a wide illumination area even use with a diverging lens. The light having a large incidence angle on the light emerging face of the diverging lens, may be totally reflected backwardly into the diverging lens. Thus, the radiation angle of the light emitted out of the diverging lens is limited, generally less than 120 degrees. In other words, the light intensity dramatically decreases when the radiation angle exceeds 120 degrees.

Therefore, what is needed is a light source device which can overcome the described limitations.

### BRIEF DESCRIPTION OF THE DRAWINGS

Many aspects of the disclosure can be better understood with reference to the following drawing. The components in the drawing are not necessarily drawn to scale, the emphasis instead being placed upon clearly illustrating the principles of the present light emitting diode device for microminiaturization. Moreover, in the drawing, like reference numerals designate corresponding parts throughout the whole view.

FIG. 1 is a schematic, isometric view of a light source device according to an exemplary embodiment.

FIG. 2 is an inverted view of a lens of the light source device of FIG. 1.

FIG. 3 is a cross-sectional view of the light source device of FIG. 1, taken along line III-III thereof.

FIG. 4 is a distribution graph of a radiation angle of the light source device of FIG. 1.

### DETAILED DESCRIPTION OF EMBODIMENTS

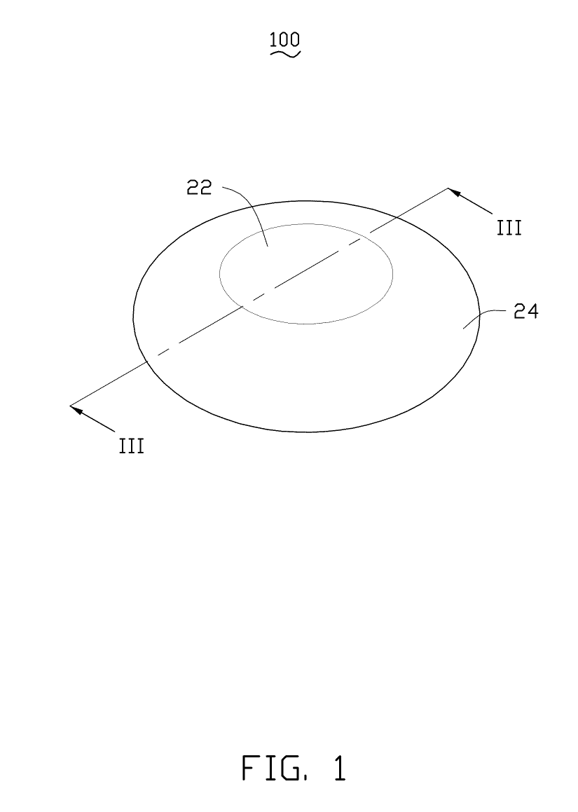

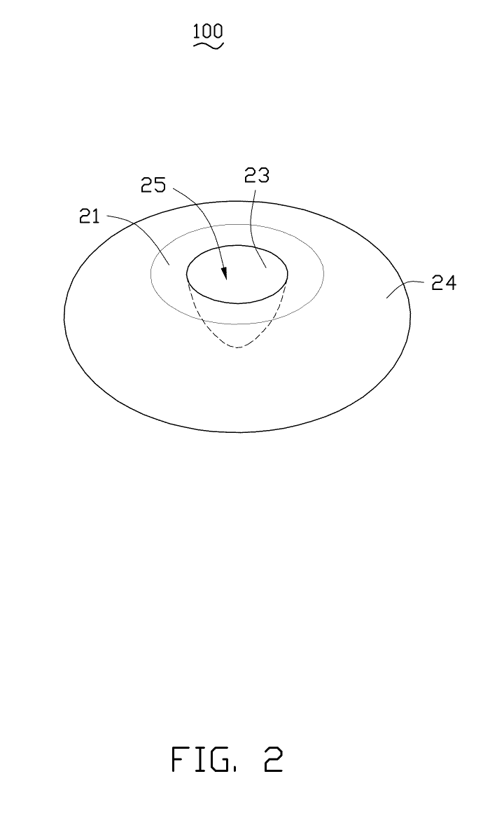

Referring to FIGS. 1-3, a light source device 100 in accordance with an exemplary embodiment of the present disclosure is illustrated. The light source device 100 includes a light source 10 and a lens 20.

The lens 20 includes a bottom surface 21, a top surface 22 opposite to the bottom surface 21, a light input surface 23 and a side surface 24 connected to the bottom surface 21 and the top surface 22. The bottom surface 21 and the top surface 22 are planar surfaces and parallel to each other. In the present embodiment, the lens 20 is made of borosilicate glass.

The bottom surface 21 and the top surface 22 of the lens 20 are substantially circular. The light input surface 23 is defined at a center of the bottom surface 21 and depressing from the bottom surface 21 towards the top surface 21 of the lens 20; therefore, the bottom surface 21 defines a cavity 25 enclosed by the light input surface 23. The light input surface 23 is an aspheric surface.

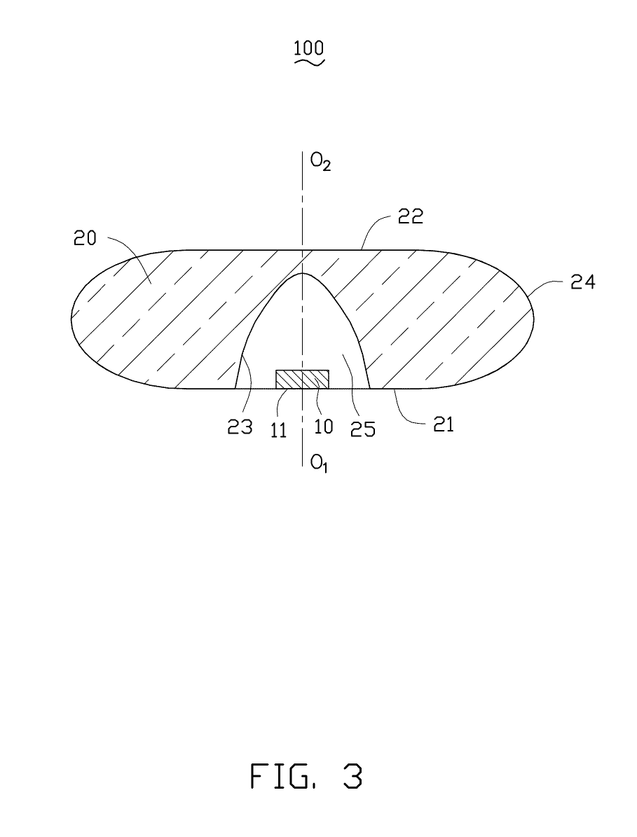

Referring to the FIG. 3, the side surface 24 connects the bottom surface 21 and the top surface 22. The side surface 24 is a curved surface formed by rotating a curve line about a central/optical axis O₁O₂ of the lens 20. In the present embodiment, the side surface 24 is formed by rotating a semicircular line about the central/optical axis O₁O₂ of the lens 20. The top surface 22 and the side surface 24 act as the light output surface of the lens 20. In the present embodiment, the side surface 24 smoothly connects the top surface 22 and the bottom surface 21, and the side surface 24 has a diameter gradually increasing and then decreasing from the top surface 22 to the bottom surface 21.

The light source 10 faces the light input surface 23 of the lens 20. In the present embodiment, the light source 10 is received in the cavity 25 of the lens 20. The light source 10 is an LED, and an optical axis of the light source 10 is coaxial to that of the lens 20. A bottom surface 11 of the light source 10 is substantially coplanar with the bottom surface 21 of the lens 20. In an alternatively embodiment, a light emitting surface of the light source 10 can be substantially coplanar with the bottom surface 21 of the lens 20.

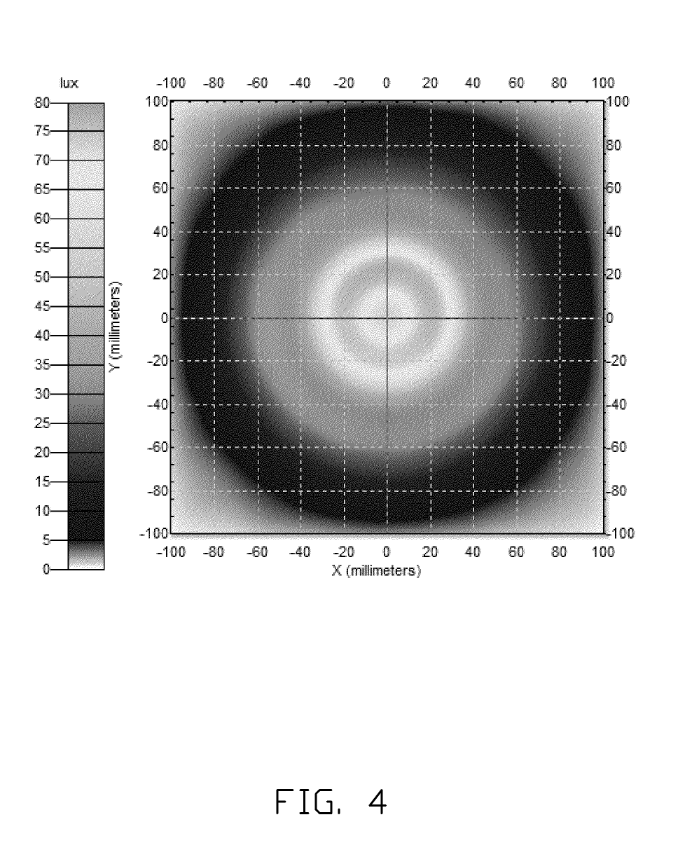

Referring to the FIG. 4, light beams emitted from the light source 10 travel through the light input surface 23 to enter the lens 20, and are refracted and diverged by the top surface 22 and the side surface 24 of the lens to outside. Therefore, it can enhance the radiation angle of the light source device 100.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A light source device, comprising a light source and a lens opposite to the light source, the lens comprising:
a bottom surface;
a light input surface depressing from the bottom surface , the light input surface being an aspheric surface;
a top surface opposite and parallel to the bottom surface; and
a side surface connecting the bottom surface and the top surface, the side surface being a curved surface formed by rotating a curve line about a central axis of the lens, light emitted from the light source entering the lens and being refracted by the side surface and the top surface of the lens to outside.

2. The light source device of claim 1, wherein the side surface is formed by rotating a semicircular line about the central axis of the lens.

3. The light source device of claim 1, wherein the bottom surface and the top surface are planar surfaces.

4. The light source device of claim 1, wherein the lens is made of borosilicate glass.

5. The light source device of claim 1, wherein the light source is an LED, and the central axis of the light source is coaxial to that of the lens.

6. The light source device of claim 1, wherein the side surface smoothly connects the top surface and the bottom surface.

7. The light source device of claim 1, wherein the side surface has a diameter gradually increasing and then decreasing from the top surface to the bottom surface.
